(19) United States
(12) Patent Application Publication
(10) Pub. No.: US 2004/0182635 A1
(43) Pub. Date: Sep. 23, 2004

(54) Tethered self propelled lawn mower

(76) Inventor: Joseph Patrick Selesky, Waterloo, IA (US)

Correspondence Address: JOSEPH PATRICK SELESKY, 1156 EAST MITCHELL AVE., WATERLOO, IA, 50702, US

(21) Appl. No.: 10/283,319

(22) Filed: Mar. 17, 2003

(51) Int. Cl. B62D 1/26; A01D 34/00

(52) U.S. Cl. 180/400; 242/398; 56/16.7

(57) ABSTRACT

A tethered guidance system for a lawnmower is provided to reduce operator fatigue and exposure to dust and debris by inserting a staked stand with a fixed spool. This spool has a circumference slightly less than the cut width of a self propelled lawnmower to allow sufficient overlap. A wire is connected to this spool through an eyelet and and is connected to the lawnmower by means of a simple bracket and snap hook. As the mower travels around the spool it is guided and retracted over the area of a circle.

### BACKGROUND OF THE INVENTION

1. Field of the Invention

This invention pertains to the guidance of self propelled lawn mowers and other self propelled vehicles.

2. Description of the Related Art

Currently there are self propelled lawn mowers and other self propelled vehicles that require an operator to guide them. There are also GPS guided vehicles that are to expensive for most people.

This invention consists of a very inexpensive way to guide a self propelled lawn mower or other self propelled vehicle over the area of a circle using a simple spool with a circumference that relates directly to the cutting or working path of a self propelled lawnmower or other self propelled vehicle and a lightweight low stretcth wire that is attatched from the spool to the self propelled vehicle.

It is well known that a self propelled vehicle requires an operator to guide it over a certain area and allow a certain amount of overlap to completely cover a given area. However when a self propelled vehicle is connected to a spool with a predertermined circumference by a lightweight lowstretch wire it will be guided over the area of a circle evenly with sufficient overlap, automatically, and unmanned operator free.

### SUMMARY OF THE INVENTION

It is the object of the present invention to provide a low cost way to guide a self propelled vehicle over the area of a circle.

It is the object of the invention to provide an easy and simple way to guide a self propelled vehicle.

It is another object of this invention to provide such a guidance system from similar existing components.

It is another object of this invention to provide an easy way to guide and control a self propelled vehicles working path overlap simply by changing the spools circumference in relation to the working path of the vehicle being guided. an example would be a 6″ diameter spool has an approximate circumference of 18″ this would allow a 2″ overlap on a 20″ lawnmower. Simply changing the spool diameter to 4″ with a circumference of approximately 12″ would allow an overlap of 8″ on a 20″ lawnmower. I have found that having a larger overlap works well in deep grass when mowing because it allows the mower to maintain its normal speed and engine rpm by decreasing its workload.

The circumference of the spool equals the amount of guide wire that is taken up each time the mower makes a complete revolution around the spool.

It is also the object of this invention to show that when the forward drive on a self propelled vehicle is engaged and maintained mechanically that a self propelled vehicle using this guidance system will operate automatically, unmanned, allowing the operator to be out of the elements, free of exposure to dust, pollen, noise, and flying debris just to name a few.

### BRIEF DESCRIPTION OF THE DRAWINGS

FIG. 1 Shows a perspective view of a pedestal and a spool connected to a lawnmower by a wire and the relationship therebetween. FIG. 1 shows a spool with a 6″ diameter and a mower with a 20″ cut width. A 6″ spool has a circumference of 18.84″ so each time the mower makes a complete revolution it will be retracted 18.84″ this will allow a 1.16″ overlap on a 20″ mower.

### DESCRIPTION OF THE PREFERRED EMBODIMENT

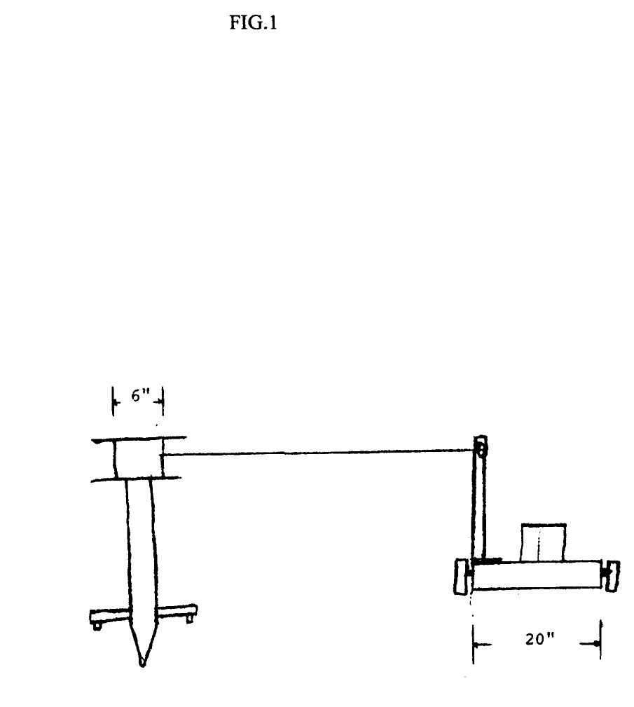

Referring to the accompanying drawing FIG. 1 shows a means of controlling and guiding a self propelled mower or any self propelled vehicle over the area of a circle.

FIG. 1 shows a spool fixed or integrated to a pedestal that is staked in the ground. This spool and pedestal could be cast as one piece and be made ornamental.

FIG. 1 also shows the guide wire and a simple bracket that connects the self propelled vehicle to the spool this wire must be a lightweight lowstretch material to maintain a steady path and to control linesag and oscillation.

FIG. 1 shows a 6″ spool that has a circumference of approximately 18″ connected to a mower with a 20″ cut width. The first revolution the mower makes around the spool will be a full 20″ cut width and each consecutive revolution the mower would cut approximately 18″ paths allowing 2″ of overlap. A smaller spool not shown could be added or cast with the pedestal that would allow more overlap.

An example would be

a 4″ diameter spool with a 12″ circumference, this would allow 8″ of overlap which works real well in deep grass when the mower cannot handle a fill width of cut or when more overlap is preferred.

FIG. 1 shows a single strand of 0.023″ steel welding wire with an approximate length of 80 feet connected on one end to a fixed spool, and on the other end to a simple bracket that is connected to a lawnmower. This wire is lowstretch and lightweight for minimum oscillation. length could be varied as as well as material and diameter.

In compliance with the statute, the invention described herein has been described in language more or less specific as to structural features. It should be understood, however, that the invention is not limited to the features shown, since the means and construction shown, is comprised of the preferred embodiments for putting the invention into effect. the invention is therefore claimed in any of its forms or modifications within the legitimate and valid scope of the amended claims, appropriately interpreted in accordance with the doctrine of equivalence.

What I claim as my invention is:

1. A method of controlling and guiding a self propelled lawnmower or other self propelled vehicle over the area of a circle using a spool that is connected by a wire or other lightweight cord The spool guides the vehicle in a circular motion, this spools diameter also controls the amount of extention or retraction as the wire is wound or unwound on to it.
